(19) United States
(12) Patent Application Publication
(10) Pub. No.: US 2013/0125835 A1
(43) Pub. Date: May 23, 2013

(54) LIVESTOCK POSITIONING APPARATUS FOR DATA COLLECTION AND SUBSEQUENT SORTING

(71) Applicants: Steven C. Sinn, Tremont, IL (US); Dennis R. Strickland, New Albany, IN (US)

(72) Inventors: Steven C. Sinn, Tremont, IL (US); Dennis R. Strickland, New Albany, IN (US)

(21) Appl. No.: 13/303,309

(22) Filed: Nov. 23, 2011

(51) Int. Cl. A01K 29/00

(52) U.S. Cl. 119/840

(57) ABSTRACT

A livestock positioning apparatus for data collection and subsequent sorting is provided including a singulating transport, a livestock data collection station, and a sorting transport. The singulating transport singulates livestock from a collection thereof and feeds them into the data collection station. The data collection station positions the livestock through a pair of body conveyors and accumulates specific measurements thereof. The sorting transport then moves the livestock along the path determined by the collected data as compared to any predetermined parameters.

### CROSS-REFERENCE TO RELATED APPLICATION

None.

### BACKGROUND OF THE INVENTION

I. Field of the Invention.

The present disclosure relates generally to an apparatus for handling livestock. In particular, the present disclosure is directed to an apparatus to affect the efficient handling of livestock during the data collection thereof and the sorting of same.

II. Description of the Prior Art.

It will be understood and appreciated that as the foregoing description of the present disclosure may be explained as it pertains to the handling of poultry, this description in no way shall be indicative of the limiting of “livestock” thereto.

It is common with some livestock, and certainly with poultry, to be kept in large groups in rather intensive confinement. Such crowding, and its inherent individual competition for limited resources, will typically create a stressful environment. As livestock welfare has a direct correlation with livestock stress, such situations, among others, lead to poor livestock well-being.

Moreover, there is currently a great deal of welfare concern about the handling and transport of poultry. The manual process of using an operative to catch poultry, contain them, transport them, and remove them from their containers only to hang them on shackles at a processing plant has always been a frequent source of stress and injury to the birds, mainly due to the quality of the manual handling. The more automated process of using various conveying apparatus to load poultry from the farm to a transport vehicle, and then unload from the transport vehicle to another farm and/or processing plant, while more advantageous than manual handling, still results is a stressful environment for the poultry.

The proper management of poultry's exposure to stressors can maximize well-being and can have beneficial effects on animal production. This is because as poultry baseline homeostatic mechanisms are challenged and/or altered, the growth, disease resistance, and reproduction of such poultry can be affected. No animal exists free from stress and suffering, let alone a meat producing animal for human consumption. Each animal responds to stress differently. It is the measurement of the physiological reaction to stresses that is an indication of animal wellbeing. For example, individual meat producing animals typically have a small variation from their genetic imprint (less than 10%). However, excessive stressors caused by per se management and environmental irregularities increase the range of individual variation beyond this acceptable genetic variation range. To put it a different way, while poultry well-being is an important humane issue, reducing or eliminating stress in animals prior to slaughter is also a meat quality'issue. In fact, it has been proven that even the last five minutes of life has a direct impact on the quality of the meat. Accordingly, the individual data of each animal provides a forceful tool to determine excessive stress.

Knowing that stress is an important factor in poultry well-being creates the issue of attempting to quantify it. With an inherent tendency in the physiological system of higher animals to maintain internal stability, so-called homeostasis, certain physiological measurements have been relied upon to quantify alternations to homeostasis. For example, such traditional physiological measurements include individual weight, heart rate, respiration rate, body temperature, body confirmation, hormone concentrations, blood flow and pressure, oxygen concentrations, etc. Accordingly, the ability to measure such data would be particularly beneficial to the livestock industry.

However, measuring such data has proven to be quite difficult. One such attempt is disclosed in US Patent Publication No. 2009/016234, which is incorporated herein by reference. The data collection station described therein, while able to collect certain data, is nevertheless somewhat lax in its positioning of livestock during data collection, which may affect the accuracy of measurements.

In view of the needs of the industry, as well as the shortcomings of the conventional systems, it is a general object of the present disclosure to provide an apparatus that overcomes the deficiencies of current practices for data collection and sorting of poultry during the live loading and unloading of livestock prior to slaughter.

It is another object of this disclosure to provide a stand-alone apparatus for quantifying poultry well-being that is capable of interfacing with current loading and unloading systems.

Another general object of this disclosure is to provide an apparatus that sorts according to the data collected.

Yet another object of this disclosure is to provide an efficient and transparent animal supply chain, while simultaneously improving animal care.

These and other objects, features and advantages of this disclosure will be clearly understood through a consideration of the following detailed description.

### SUMMARY OF THE INVENTION

According to an embodiment of the present disclosure, there is provided an apparatus for positioning livestock in order to singulate and collect data thereform. The apparatus includes a singulating transport for feeding livestock into a data collection station comprising body support and cover transports. Once data is collected, the livestock is sorted according to the collected data.

There is also provided a livestock data collection station including a foot transport for feeding individual livestock into the station and a pair of body support transports with a cooperating cover transport for receiving the livestock. The body transports form a “V” under the cover transport to hold the livestock for a data collector.

There is further provided a livestock positioning apparatus for data collection and subsequent sorting including a singulating transport for separating individual livestock from a group of livestock and a data collection station for receiving livestock within body support transports arranged in a “V” and under a cover transport. A data collector then collects individual livestock data which is processed so as to enable a sorting transport to direct the livestock.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a perspective view of a livestock data collection and sorting apparatus according to the principles of an embodiment of the present disclosure.

FIG. 2 is a top plan view of the apparatus of FIG. 1.

FIG. 3 is a side elevated view of the apparatus of FIG. 1.

FIG. 4 is a rear elevated view of the apparatus of FIG. 1.

FIG. 5 is a frontal perspective view of a livestock data collection and sorting apparatus according to the principles of an embodiment of the present disclosure illustrating the data collection of livestock.

FIG. 6 is a rear perspective view of the apparatus of FIG. 5.

FIG. 7 is a perspective view of a livestock unloading station.

FIG. 8 is a perspective view of the coupling of the unloading station of FIG. 7 with the apparatus of FIG. 1.

FIG. 9 is a top plan view of the apparatus of FIG. 1 coupled to a sorting station.

FIG. 10 is a side elevated view of FIG. 9.

FIG. 11 is a rear elevated view of FIG. 9.

FIG. 12 is a cross-sectional view taken along lines 12-12 of the sorting station of FIG. 9.

### DESCRIPTION OF THE PREFERRED EMBODIMENTS

The following description of the preferred embodiments is merely exemplary in nature and is in no way intended to limit the disclosure, its application or use.

Turning now to the drawings, an embodiment of the present disclosure provides for a livestock data collection and storing apparatus that has been designed to be utilized as a standalone unit and/or integrated at the end section of a livestock loading and/or unloading system. Whether standalone or interfacing with other systems, the basic features and advantages will be described as they relate to the drawings.

For illustrational purposes, it will be understood that some of the drawings may not show cooperating walls, covers or transport framing. This has been done so as to more clearly describe the interactions amongst the different livestock transporting and data collecting areas of the apparatus. It will be further understood that certain confirming and/or support members may be utilized.

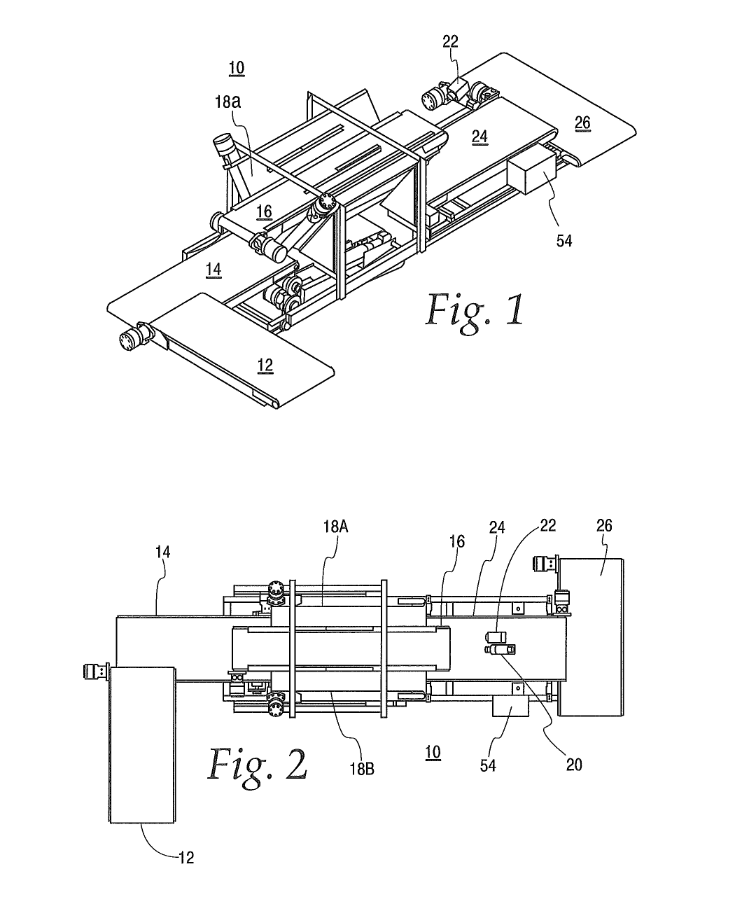

In any event, livestock data collection and storing apparatus 10 of FIGS. 1-3 has a base unit that consists of multiple conveyors for both livestock transport and livestock data collection. In particular, singulating conveyor 12 stages or accumulates birds utilizing different lengths and connecting angles as it receives the livestock and singulates them onto the feeding conveyor 14. The feeding conveyor 14 then feeds the livestock under the cover or hold down conveyor 16 and between a pair of body support conveyors 18a, 18b. An infrared camera 20 as well as a digital camera 22, scanners or the like, take their respective images and/or video of the livestock as it is conveyed onto the scale 24 where it is weighed. The area of the body support conveyors and hold down conveyor and/or the scale comprise the data collection station of the apparatus. It is envisioned that there will be multiple sets of different kinds of cameras used during the data collection process. For example, as the livestock is moved towards the scale 24, there may be a set of cameras on the left, on the right, and in front of the livestock, all of which providing, for example, a 90° field of the view. In any event, the sorting conveyor 26 then directs the livestock depending upon attributes relating to limits set by the user on the data collected.

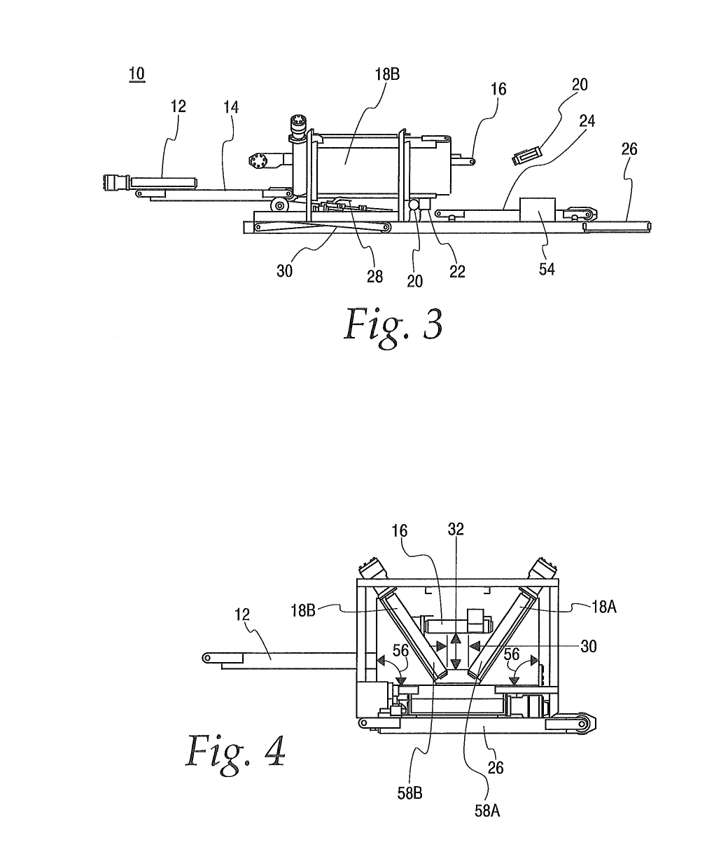

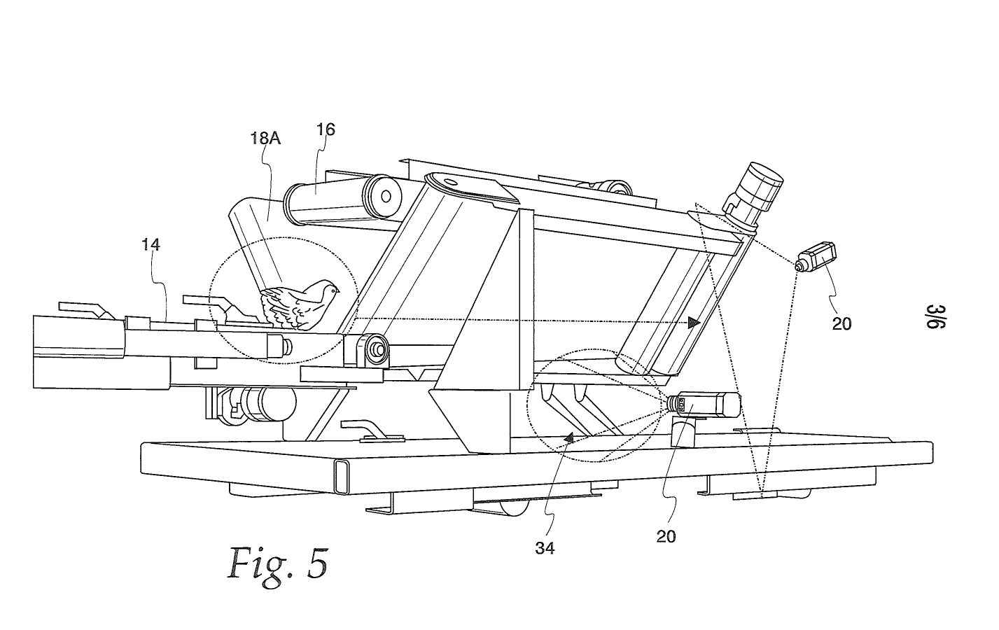

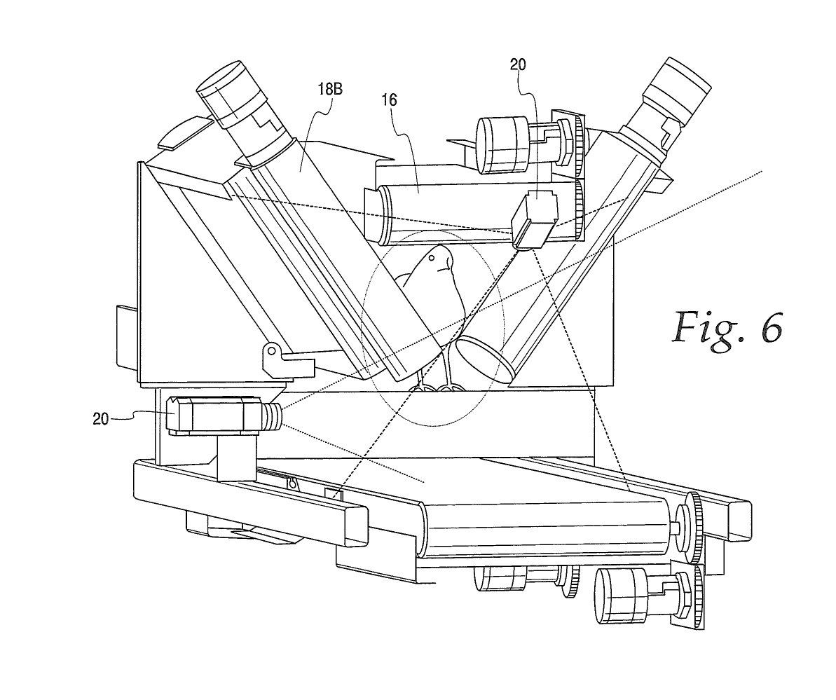

The data collection aspects of the apparatus 10 will now be more particularly described as they relate to FIGS. 3-6. The poultry (livestock) are positioned via the feeding conveyor 14 to enter between the pair of body support conveyors 18a, 18b (V-conveyors) and under the hold down conveyor 16 either head or rear first. The poultry is initially contained/positioned in a crouch within these three conveyors. As the poultry continues its transport, the declining foot support conveyor 28 enables the poultry to settle between the V-conveyors. Depending upon what type of poultry is being moved, the foot support conveyor 28 is adjustable via a scissor height adjustment member 30. Furthermore, and as more particularly shown in FIG. 4, adjustment to the height of the hold down conveyor 16, and the width of the V-conveyors 18a, 18b, enable user setting for size (turkeys, chickens, etc.) of the poultry. Specifically, the girth or width 30 is adjusted by the relative positions of body support conveyors 18a, 18b and the height 32 is adjusted by the relative position of the hold down conveyor to the body support conveyors 18a, 18b. Furthermore, the angle of each body support conveyor, relative the feeding on support conveyors, is similarly adjustable. Ideally, the livestock is positioned such that it is comfortably held between the V-conveyors during at least a portion of the data collection process.

With the proper adjustments made to accommodate the particular poultry size, the legs, feet and toes 34 as well as the overall underside of the bird are exposed for images to be taken and recorded by cameras and the like. Such a moment video shot can be attained, for example, to detect heat gradients/measurements of the hock/legs/footpad/toes. Such measurements, and in particular compromised measurements, are easily understood by the retail audience. For example, recognizing an above average heat reading in this area would represent perhaps an infection and/or a point of pain or perhaps the morbidity of an animal. Similarly, allowing a full body picture of the poultry will enable, for example, detecting feathering issues as well as other body/feathering abnormalities.

The poultry then exits the data collection area of the apparatus 10 and the sorting conveyor 26 sorts them depending on prescribed criteria. For example, acceptable birds may be placed on a subsequent conveyor until a container unit has been accumulated and then conveyed to a head section of a poultry loading apparatus and loaded on a transport trailer. On the other hand, birds that may be compromised can be sorted onto another conveyor or conveyors where they will be visually inspected for further review and/or conveyed to the loader and subsequently loaded in a separate contained unit and perhaps ear marked as birds with certain physical aspects.

Poultry can be sorted by any number of attributes and virtually any collectable data may be used to sort. For example, assume that the apparatus 10 is being utilized at a processing plant for sorting prior to stun and the average chicken on an arriving transport vehicle weighs 6.15 pounds. The sorting system can be adjusted to displace 4.15 pound chickens (for example) or less into a sort conveyor. Once enough 4.15 pound chickens have been accumulated to achieve a full container unit, the chickens proceed to be conveyed through the loading system and into a container on the trailer.

The apparatus 10 can be utilized to collect data at the farm before initial transport as well as after transport and before processing at a plant. Data collected is then accessible through the entirety of the poultry's journey from farm to consumer. As such, the next destination (and the final destination) will know what is coming (it has) before it is unloaded (consumed). While each individual bird can be tagged (via RFID or otherwise), data can otherwise be assigned by location of the bird (e.g. coop module, container, shackle, package, etc.). An example of such tracking that can be utilized with the present disclosure is found in U.S. Publication No. 2009/0164234 to Sinn et al., incorporated herein by reference.

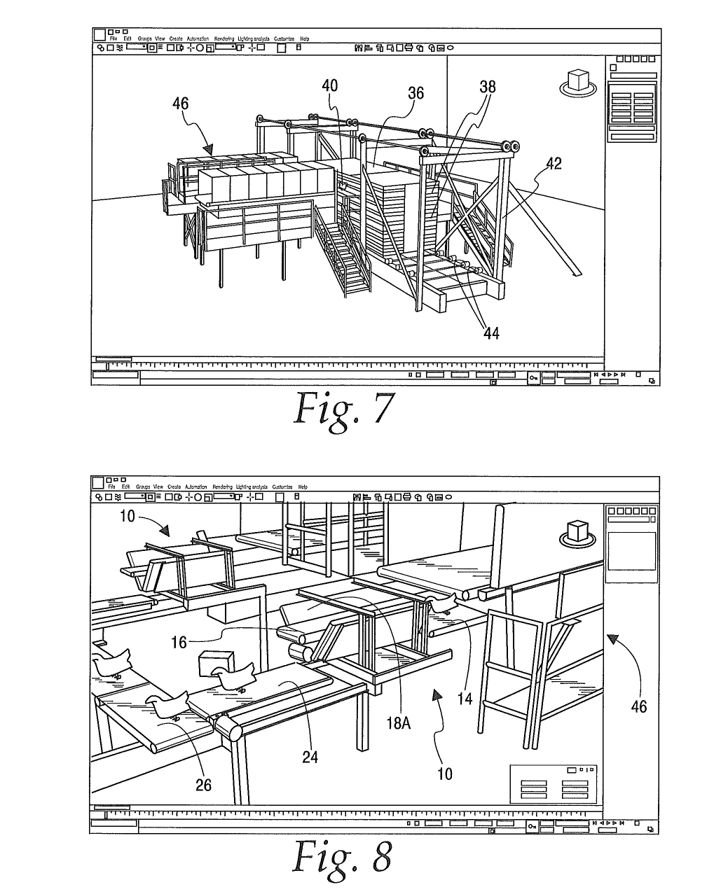

The interaction between the apparatus 10 and where the poultry is fed from as well as where it is sorted after data collection will now be described with regard to FIGS. 7-12. It will be understood that the foregoing description is for illustrational purposes only as the apparatus can be utilized at any point in the chain between farm and consumer. In any event, FIG. 7 shows a module 36 with coops filled with poultry 40. This particular module 36 may have been dropped into the holding frame 42 from above or it may have been positioned within the frame 42 from one of the ends through the use of rollers 44. Once positioned, poultry can be unloaded through the use of a plant unloader system 46, for example.

FIG. 8 shows a pair of cooperating apparatus 10 coupled to a plant unloader system 46. Poultry is transported from the feeding conveyor 14 and positioned under hold down conveyor 16 and between V-conveyors 18a, 18b. There poultry is then momentarily held or slowly conveyed for consistently successful data collection by scanning/picturing/videoing before moving on the scale 24 for weighing and then on to the sorting conveyor 26.

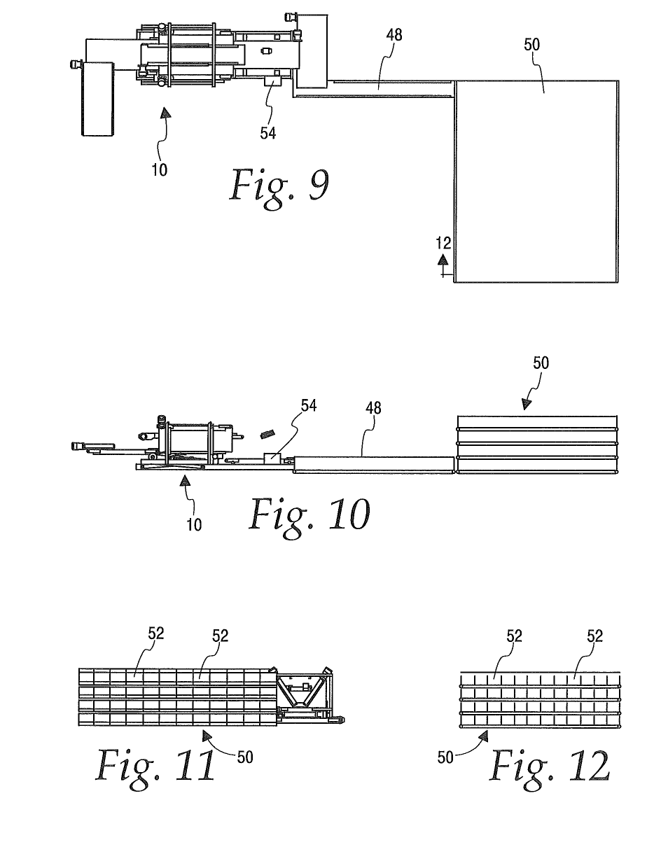

Turning now to FIGS. 9-12, a sorting scheme that may be implemented by the apparatus 10 will be shown and described. While the top plan view of FIG. 9 shows a single apparatus 10 coupled to a storage conveyor 48 and a holding/storage/stunning module 50, it will be understood that multiple apparatus may be used at the same time. In any event, the sorting conveyor 26 moves as determine by the data collected from the cameras and scales, for example, when compared to the preset parameters in the systems processor. Similarly, storage conveyor 48 is movable relative to the apparatus 10 and the module 50 to transport poultry into the appropriate space 52 within the module 50.

Before any data can be collected and therefor any sorting according to such collected data, the livestock needs to be positioned to collect the data. Livestock positioning is accomplished via manually controlling the various transport conveyors and/or is automatically controlled via processor 54. In any event, it is the ability to singulate and gap the livestock into a position to collect data that provides one of the advantages of the present disclosure. Once singulated and gapped, it is the unique positioning of the present disclosure that enables the necessary accuracy to the measurements of the data.

More specifically, and turning back to FIG. 4, the body support conveyors (V-conveyors) 18a, 18b are arranged at an angle 56 to the horizontal transporting and hold down conveyors. It is this angle 56 that enables the V-conveyors, once correctly adjusted as previously discussed, to hold the body of the livestock generally above the bottom ends 58a, 58b of the V-conveyors while their limbs generally hand below. The angle 56, as the width 30 and height 32, are adjustable to accommodate different sized livestock. This positioning of the poultry (livestock) enables accurate data collection through the various cameras and otherwise.

The apparatus 10 is controlled and data is collected, stored and analyzed through the aid of the controller (processor) 54. More specifically, the data collected can be added to a database and each animal can be analyzed according thereto. For example, the data collected may be utilized within a live animal index which may be comprised of factors obtained as a result of the data. Such factors may include flock mortality, individual weight variation within the flock body temperature, photograph or other factors according to some predetermined directive.

Other data which may be collected would include more precise measurements such as bone structure, blood/oxygen concentrations, enzyme detection, DNA cursors, etc. Whatever data that may be collected, it is first entered into and analyzed by the control unit and processor 54. As previously noted, such data will be associated with a specific animal either by keeping track of the order that the animal has moved through the system or by an individual marking system such as a RFID system.

Through the use of RFID or other individual tracking tools, the relevant information about specific animals will be readily available upon request from the supply chain, retailers and consumers. This may be accomplished in any number of ways. It is envisioned that the collected data may be accessible through the internet, intranet or the like. Alternatively, the data may be transported with the animals on any number of memory devices (i.e. thumb drive, flash, etc.). However the data is transferred, one mission of the present disclosure remains the improvement of the efficiency and the transparency of the animal chain, while improving animal care. In fact, it is the use of the critical control point data that equips the supply chain to measure performance and to substantiate animal state of being.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A livestock positioning apparatus comprising:
a singulating transport for separating individual livestock from a group of livestock;
a data collection station for receiving livestock from said singulating transport and collecting data from individual livestock, said collection station including livestock body support transports arranged under a cover transport; and
a sorting transport for receiving the livestock from the collection station and directing them according to said data.

2. A livestock positioning apparatus as defined in claim 1 wherein said transports are conveyor belts.

3. A livestock positioning apparatus as defined in claim 1 wherein said station includes a camera.

4. A livestock positioning apparatus as defined in claim 1 wherein said station includes a scale.

5. A livestock positioning apparatus as defined in claim 1 wherein said body support transports are arranged at an angle forming a “V transport” for holding said livestock therebetween.

6. A livestock positioning apparatus as defined in claim 1 wherein said station includes a declining foot support transport.

7. A livestock positioning apparatus as defined in claim 5 wherein said cover transport and said V transport are adjustable to accommodate various sized livestock.

8. A livestock data collection station comprising:
a foot support transport for feeding individual livestock into said station;
a pair of body support transports and a cooperating cover transport for receiving said livestock therebetween, said body support arranged at an angle to form a “V” to hold said livestock therebetween; and
a livestock data collector.

9. A livestock data collection station as defined in claim 8 wherein said data collector is a camera.

10. A livestock data collection station as defined in claim 8 wherein said data collector is a scale.

11. A livestock data collection station as defined in claim 8 wherein said foot support transport is declining.

12. A livestock data collection station as defined in claim 8 wherein said transports within said station are adjustable to accommodate various sized livestock.

13. A livestock positioning apparatus for data collection and subsequent sorting, said apparatus comprising:
a singulating transport for separating individual livestock from a group of livestock;
a data collection station for receiving livestock from said singulating transport and collecting data from individual livestock, said collection station including livestock body support transports arranged in a “V” and under a cover transport;
a data collector;
a processor for receiving data from said collector; and
a sorting transport for receiving livestock from the collection station and directing them according to processed data.

14. A livestock positioning apparatus for data collection and subsequent sorting as defined in claim 13 wherein said data collector is a camera.

15. A livestock positioning apparatus for data collection and subsequent sorting as defined in claim 13 wherein said data collector is a scale.

16. A livestock positioning apparatus for data collection and subsequent sorting as defined in claim 13 wherein said transports within said station are adjustable to accommodate various sized livestock.
